(19) United States
(12) Patent Application Publication
(10) Pub. No.: US 2010/0082392 A1
(43) Pub. Date: Apr. 1, 2010

(54) MULTI-OBJECTIVE OPTIMIZATION FOR ALLOCATION OF ADVERTISING RESOURCES

(75) Inventors: Jian Yang, Palo Alto, CA (US); John Tomlin, Sunnyvale, CA (US)

Correspondence Address: Mauriel Kapouytian & Treffert LLP, 151 1st Avenue, #23, New York, NY, 10003, US

(73) Assignee: YAHOO! INC., Sunnyvale, CA (US)

(21) Appl. No.: 12/241,657

(22) Filed: Sep. 30, 2008

(51) Int. Cl. G06Q 30/00

(52) U.S. Cl. 705/8; 705/14.13

(57) ABSTRACT

An advertising distribution system mediates and distributes advertising opportunities, especially insertions of ads on web pages, according to advertisers' representative targeting profiles. The number and characteristics of future ad impressions is forecast. A portion is allocated to guaranteed-delivery advertiser contracts and the remainder is offered on a spot market. A division between guaranteed and spot market allocations is sought to maximize revenue, taking into account a value associated with meeting the advertisers' representative profiles. The value of representativeness can be inferred from the marginal revenue of a spot market sale, and optionally weighted. The guaranteed and spot market revenues for all possible efficient allocations produces a curve. An operating point on the curve is determined by selecting a weighting factor or selecting a proportion of total revenue that shall be attributable to representativeness.

### FIELD OF THE INVENTION

The allocation of increments of a supply to meet demand is optimized in a market for use of advertising opportunities (ad impressions) by establishing a proportion of revenue and/or quantity to be shared between distinct categories of demand with potentially different marginal values. A programmable technique divides all allocations that are projected and later the allocations that actually arise, between a category of pre-committed increments, typically contractually committed ad insertion opportunities with predetermined characteristics, and a category of spot sales, typically ad insertion opportunities that become available in excess of projections.

The supply of ad impression opportunities preferably comprises a opportunities to insert on-line advertising (“ad impressions”), such as inserting variable banner ads into web pages that are transmitted to users. The ads can be allocated selectively, based on characteristics of the user or typical users of the particular web page, or otherwise selected to match user and content information, location, timing and other criteria to advertiser specifications, for targeting the ads to potential customers.

### RELATED ART

A market exists for the distribution of advertising and other information over data communications and entertainment networks. An apt but non-limiting example is insertion of advertising copy supplied by advertisers, for more or less prominent appearance on web pages content offered by media distributors such as news and information services, internet service providers, and suppliers of products related to the advertiser's products or services.

The value of an opportunity to present an ad (i.e., to exploit an “ad impression”) is different for different advertisers and different web page or entertainment genres, because the content of the media delivered by a particular media outlet draws users of a certain type that may correlate more or less strongly with a population of potential customers that an advertiser seeks to reach. Variation in the value of ads, plus the ability to discriminate among ad recipients as a function of the variable content of the web pages they access, plus the ability to shift selectively to route appropriate ad content to a selected user when a web page is rendered, make on-line network communications a very useful and efficient environment for advertising, and especially for targeted advertising.

The network could be the worldwide web and the advertising copy could comprise banner ads, graphics in fields of specific size and placement, overlaid moving pictures or animation, redirection to a different URL, etc. The same targeting abilities are also applicable to networks that are interactive to a lesser degree, such as cable television ad insertion, which might be done at a head end or at a hub, or even from a subscriber-specific set top box.

Even in the best situations, one cannot conclude definitely that any given subject will respond favorably if exposed to information or advertising, for example by purchasing an advertised product or service. But one can establish a set of variables to characterize members of a population, to determine values for those variables that are most characteristic of actual purchasers (and by implication to assess the quality of ad targets). Statistical methods enable correlation of a set of variable values with selected subsets of the population consistent with purchasers. Statistical methods also enable correlation among the variables themselves. The result is a set of criteria such as age, gender, location, income range, education, family status, etc., and various rules of thumb that attempt to use combinations of certain values of these criteria to make conclusions about the characteristics and buying preferences of customers.

Variably defined subsets of the population are thereby rated for the likelihood that members of each subset will become a purchaser if exposed to advertising. The subsets of the population can be distinguished by the extent to which members are correlated to an ideal target for an advertising piece.

There are mathematical ways to correlate variable values that may be known about the population of subjects with other variable values that may not be known. There are also ways to infer information such as descriptive and demographic details about subjects, based on the subject's current activities, including the websites that a subject may be visiting, the entertainment programs being viewed, the periodical publications that the person reads, etc. If an advertiser is promoting a product that is associated with the content of a website or a publication, then advertising on the website or in the publication is more valuable to the advertiser than advertising elsewhere or randomly, because the subjects who will be exposed to the advertising are relatively more highly correlated with likely purchasers than other subjects and are more likely to actually see the advertising.

An advertiser typically does not have close access to an isolated population of subjects who are all very highly correlated with an ideal likely purchaser. Even if the advertiser had access to such a population, the advertiser would not devote 100% of its advertising effort to that population. The advertiser also would want to devote advertising efforts to other populations that are perhaps not so highly correlated, but where advertising still has a positive effect. For example, an advertiser typically seeks to spread advertising expenditures over a wide range of subjects and over a wide geographic area, while perhaps biasing its efforts toward subjects who are or might be correlated with a hypothetical ideal purchaser.

The advertiser conceives of a profile of representative advertising over which advertising expenditures shall be devoted. This profile is discussed with possible advertising outlets such as advertising brokers, advertising services (including on-line services such as that offered by Yahoo!), media outlets such as web page operators and cable media distributors, print publishers and others similarly situated. Negotiations ensue on the basis that the party controlling the ad impressions demands payment and competing advertisers who want to use the ad impressions are willing to pay for the ad impressions in amounts that related to the extent to which the ad impressions match the advertisers' representative profiles of what the advertisers demand. Matching the use of impressions to adhere to the representative aspects sought by the advertiser is an objective. Maintaining “representativeness” achieves long term value.

The market for advertising on Internet webpages is particularly well developed because information is available to characterize the webpage users (the potentially targeted subjects). Infrastructure is in place for changeably inserting ad graphics and moving pictures, such as Internet browsers. Data from click streams and sometimes from locally stored cookies can carry context and history information forward in time as the user surfs through different pages. Internet service providers make at least generalized information on subscribers available routinely, such as the subscriber's zip code. These information sources enable information to be collected to gauge the characteristics of users and enable an advertiser to define a representative advertising allocation for which the advertiser will contract.

Internet webpage operators are also in a good situation for collecting data about information distribution events, such as reporting on the availability and use of ad impressions. Executed ad impressions can be counted and reported with associated context information, time of day, location of recipient and so forth. This information enables the operators to forecast the number of impressions and the characteristics of users that are likely to be available to receive impressions ready to be allocated to those users at a future date and time. The information allows up to the moment monitoring of use of the ad impressions for reporting compliance with contractual obligations to distribute a given number of ads of a given type in a given time window.

Advertisers contract with advertising distributors and advertising services to make use of ad impressions that are available to the distributor or service. The advertising distributor might be a website operator or an advertising warehouse that in turn contracts with website operators. Available impressions are defined in number and with respect to attributes that determine the value of the impressions to the advertiser. The attributes are characteristics that enable the advertiser to judge how representative the recipients of the impressions will be, compared to likely purchasers and to the advertiser's desired profile of ad distribution. The advertising distributor may agree to distinguish among potential users to whom impressions will be delivered, for example by the attributes of the users or the web content that the users view. This aspect is written into the contract. The advertising distributor commits to delivering a given number of impressions to users of defined characteristics or in a defined context over a given time window at some point in the future.

The advertiser may contract with the advertising distributor to deliver a stated number of ad impressions to a stated number of website viewers having stated demographic or other properties that correspond with the representativeness aspects dictated by an advertiser. But there may be alternative ways in which the website operator could meet its obligations. As a simple example, if the agreement is to deliver impressions to users in a certain age group, the website operator might devote a large ratio of available impression opportunities at a time of day when the on-line user population of the age group is low, or a smaller ratio of available impression opportunities at a time of day when the percentage of users in that age group is higher, and in either case get the number of impressions needed to meet the contractual obligation.

The website operator or other advertising distributor has degrees of freedom in which to operate but may need information to define the variations in users by factors that matter, such as the correlation of user age to time of day of on-line access, in the example of a time discrimination aspect. There are various such correlations possible between category ratings that are known or might be inferred.

In order to assess its ability to meet contractual obligations, the advertising distributor projects an estimate of the number of users of given characteristics at some future date and time when offering to sell ad impressions to an advertising campaign manager negotiating for the advertiser. If the seller of ad impressions (the advertising distributor) guarantees that a certain number of ad impressions will be executed to users of given attributes, the seller is bound to comply, subject to possible contractual penalties.

A seller may decide prudently to guarantee a number of available impressions that are relatively sure to be available at the future data and time. Then if an excess number of impressions actually become available for execution at that time, the seller may seek to exploit them in sales under short term contracts, in an ad hoc spot market or by auction that could occur at any time up to the moment that an ad impression is used. The impressions that were committed by contract according to prudent projections made ahead of time can be deemed “guaranteed” impressions. The remaining impressions are “excess” or “non-guaranteed” impressions and might be sold on last minute terms or on “best efforts” commitments by the ad distributor.

In existing markets for on-line advertising, the manner of sale and the use of guaranteed and non-guaranteed ad impressions are distinctly different for the two types. Based on their confidence in projections of ad availability, the seller of ad impressions may prefer to sell guaranteed impressions and to develop long term relationships with advertisers characterized by dependability in meeting obligations. However, undue caution when making projections may leave saleable ads unsold, or may affect the prices that quality ad impressions may command. Furthermore, the ability to correlate user characteristics with ad impressions accurately may be best immediately before the ads are used. Therefore, some of the highest quality ads (namely those that are highly correlated with some desired target category) arise only after it is too late to handle them in guaranteed contracts. For these impressions, a second marketplace is advantageous, apart from the marketplace in the sale of projected future impressions under contracts that contain obligations as to the number of impressions that will be provided. This second marketplace is not based substantially on promises of future performance and instead is based on exploiting currently available opportunities.

If the advertising distributor was cautious when negotiating contracts to sell guaranteed impressions, the advertising distributor may have reserved a substantial portion of the impressions that were projected to become available, to avoid contractual penalties if the projections prove too optimistic. These need to be sold or else wasted.

If impressions become available that are matched to an advertiser's representative profile, the impressions have a high value in advertising effectiveness to that advertiser. These non-guaranteed impressions might be sold at a high price. Assuming that some proportion of projected impressions are to be reserved to ensure the ability to meet obligations, a problem is presented in how optimally to allocate the impressions between the guaranteed and not guaranteed categories when planning and negotiating contracts for use of projected future ad impressions. Assuming that the decisions have been made, the situation may change when projections are proved or disproved in reality. There is a need optimally to allocate emergent supply of ad impressions either to obligated/guaranteed impressions or to non-guaranteed impressions, in a manner that is agile and quick.

There are multiple objectives to consider. The advertising distributor needs to meet his contractual obligations, and deliver quality impressions to the advertiser in exchange for value received. The advertising distributor's long term performance under these objectives, including meeting contractual obligations for delivery of guaranteed impressions, is important to maintaining mutually beneficial relations between the advertising distributor and its customers, namely the advertisers.

The advertising distributor needs to maximize revenues obtained in exchange for use of the ad impressions that are available. Revenues can be maximized if accurate projections can be made, including forecasting the supply of impressions that will be available, assessing the demand for guaranteed impressions and forecasting the future demand in the event of short notice ad hoc sales of excess impressions, by auction or otherwise.

The foregoing situation can be considered a confluence of overlapping marketplaces. For each marketplace, the impressions (information exposures) that are available according to projections, or the impressions that actually prove to be available when the time arrives, each represent a finite supply of information distribution opportunities. These information distribution opportunities need to be allocated to the demand for use of ad impression opportunities associated with highly representative advertiser-targeted groups. The allocation needs to maximize representativeness of ad impressions compared to the advertiser's targeting, which comes from ensuring that guaranteed impressions are faithfully delivered. The allocation needs to maximize the revenue to the advertising distributor, who may be a media operator, by ensuring that no impressions go unsold, or are sold at prices that are less than the ad impressions should reasonably command.

A given number of impressions is projected to be available. If the advertising distributor decides to use some number of the projected impressions under guaranteed contracts, then the number available for ad hoc auction is reduced, and vice versa. What is needed is an optimal and efficient technique to control the relative allocations of guaranteed ad impressions under contracts versus non-guaranteed ad impressions to be sold on the spot market.

### SUMMARY

It is an object of the present disclosure to provide a technique for balancing an allocation of a total resource into at least two categories, wherein the categories can have different rates of return on the resource and also can have additional competing reasons for favoring one category over another.

It is another object to provide a method by which a reasoned division can be made in exploiting a resource whose total amount and value are uncertain but can be estimated. The resource is allocated between two categories in a manner whereby allocation of a part of the resource to either category reduces the allocation available for the other category. One category is an amount of the resource to be committed according to terms of sale that are to be determined, for example including consideration to be paid in an amount to be determined by negotiation between a buyer and a seller. Another category is the projected excess that is estimated (and in the end the amount that is actually realized, if any) over the amount of the resource committed according to the terms of sale.

According to certain advantageous embodiments, the resource to be allocated is advertising impressions. The two categories of allocation are, first, the number and perhaps the character of ad impressions that will be committed to contractual obligations based on use of projected available ad impressions at some future time, and second, any excess ad impressions that prove to be available at the future time, and by then have not been committed to contractual obligations. The excess ad impressions are to be sold on a short term ad hoc basis if possible, for example at auction in exchange for whatever amount the market will bear.

The terms of sale of the committed amount of the resource and the amount to be realized on the excess are not known but can be inferred to fall somewhere between zero and a maximum. The consideration for the projected excess is likewise unknown but will fall between zero and some maximum. These ranges between zero and respective maxima can be set widely. One normally can conclude for practical reasons that a prudent operating point will not press the maximum or minimum ends of either range.

In addition to the foregoing projected ranges, it is known that the sum of the allocations to the two market categories (guaranteed and non-guaranteed) cannot exceed the sum of the total ad impression supply. A marginal increase in the supply allocated to one category will inherently cause the same marginal decrease in the supply allocated to the other category.

Another objective is imposed, namely to use the total supply of ad impressions if possible. Therefore, it is assumed that the sum of the allocations to the two market categories (guaranteed and non-guaranteed) shall exactly equal the sum of supplies. According to one aspect, these considerations produce a set of relationships. The relationships can be plotted to determine the full range of possible allocations that would provide an equal return at or near a maximum that is theoretically possible. This results in a graphic representation of the alternative possible allocations of supply to one and the other of the two demand categories.

According to another aspect, when assessing an optimal allocation (and before choosing an operating point in the range), a weighting function can be applied that will mathematically favor contractual commitment of guaranteed ad impressions over ad hoc sale of non-guaranteed impressions to a highest bidder, or vice versa. The weight function can be a factor or a fraction. The weight function enables the choice of an operating point to be based on a reasoned business decision of whether one should seek to maximize customer relations (thereby weighting in favor of allocation to the guaranteed demand category) or to maximize the ability to obtain the highest possible return.

Preferably, the revenue values separately attributable to contractually committed allocations and ad hoc sales are calculated for all weight functions over a range (e.g., zero to 100%), on the assumption that the total supply and the total allocation are equal. The result corresponds to a curve showing all the points along a function line at which revenue is maximum, but at different points is proportionately more due to contractually committed allocations or more due to ad hoc sales, depending on where on the curve a point falls.

This technique reduces the problem of allocation from a supply in two different ways with two different revenues bases, down to a problem with only one choice to be made. That choice is the weight to be applied, if any, to favor contractually committed sales versus ad hoc sales. A management selection is made, whether and how much to favor revenue gleaned from contractual commitment (adhering to the representativeness sought by advertisers and seeking long term commitments) versus revenue from sales to the highest bidder, potentially at the last moment, resolve the exact number of supply units to be allocated to one or the other of the categories of contractual commitment or ad hoc sale.

In general, the method involves allocating supply and demand in connection with delivering value in exchange for revenue, including obtaining at least prospective access to a plurality of supply increments that form a total supply to be allocated to meet demand increments. More particularly, the demand is the desire to use ad impressions of predetermined characteristics. The supply is the projected number and characteristics of ad insertion opportunities during a planning phase and the actual number and characteristics of ad insertion opportunities when actually transmitting media and inserting ads.

The demand increments fall into at least two distinct categories having at least one of quantities and revenues that differ between said categories. A relationship is projected for at least one of the quantities and revenues from allocating the total supply more or less to one or the other of the at least two distinct categories, wherein the proportions range from zero to a maximum proportion of the total supply. The sum of projected quantities for all the proportions equals the total supply, and the relationship defines the full range of possible proportions of allocation between the two categories. What remains is to determine the operating point.

At least one goal is imposed on the relationship. The goal determines a point in the relationship that corresponds to a particular proportionate allocation. The supply increments are allocated to the demand increments at this particular proportion in at least one of a planned allocation and an actual allocation including delivering the supply increments.

### BRIEF DESCRIPTION OF THE DRAWINGS

The drawings depict several embodiments as examples of the subject matter in connection with the following description. The disclosure of examples is not intended to limit the subject matter of the disclosure and claims to these examples alone, variations are possible within the scope of the appended claims. In the drawings,

FIG. 1 is a block diagram illustrating the activities and relationship of advertisers and media distributors who may choose to make ad impressions (opportunities to present ad copy) available to the advertisers for a price.

FIG. 2 is a block diagram of an advantageous operating system for handling projection of available ad impressions in the future, preliminary allocation of a predetermined proportion of the supply to guaranteed or non-guaranteed contracts as described herein, and to effect that actual allocation of emergent supply (ad impressions that become available) to satisfy guaranteed contracts or to sell on the spot market, as such supply becomes available for use.

FIG. 3 is a graphic depiction of all possible allocation proportions between guaranteed commitment of ad impressions and non-guaranteed sale, e.g., on a spot market, and is discussed in connection with using weighting to determine an operating point based on the value associated with representativeness or quality as defined by the advertisers' representative profiles.

FIG. 4 is a graphic depiction of allocation proportions as in FIG. 3, but in this arrangement the operating point is determined from a proportion of revenues to be associated with representativeness.

### DETAILED DESCRIPTION

An efficient and organized technique is needed to satisfy the demand for distribution of advertising to users. The users can be more or less specifically defined by user characteristics. From the advertisers' perspective, an objective is to enable ads to be targeted to users as a function of the users' characteristics. The users' likely characteristics are known to the media outlets that serve the users, at least because user characteristics correlate with the content of media outlets that the users visit. Often the media outlets may have access to additional subscriber information from browsing history, stored cookies and other factors. The advertisers have preferences and rules for distribution of ads, that may include guidelines based on likely user characteristics and also rules for spreading advertising coverage over a range of users. All such rules, guidelines and preferences on the part of an advertiser, which might result from studies and marketing plans, together define a representative profile of the advertising demand of that advertiser. An advertiser's representative demand profile corresponds to a subset of all opportunities that might become available to insert and display an ad (all the “ad impressions”), and may include some insertions that are of more value to the advertiser than others.

Likewise, from knowledge of user characteristics and from projections of the likely range of users who may be interested enough to visit a certain type of media content in the future, the media outlets can make estimates of the numbers and characteristics of users that are likely to be subject to advertising impressions that might be devoted to displaying an advertiser's content. There is a supply and demand market involving discriminating for ad impressions that meet an advertiser's representative demand profile, allocating and using the ad impressions that arise to meet incremental parts of the representative demand, reporting to the advertiser and collecting revenue in exchange for this service.

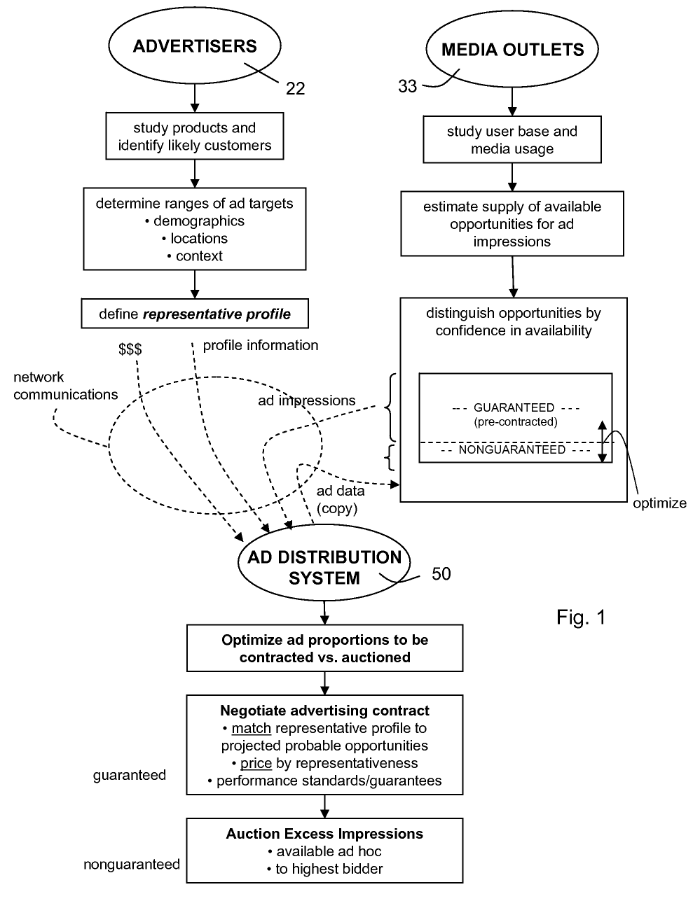

As illustrated in FIG. 1 a method and system support a marketing relationship among advertisers 22, media outlets 33 and an ad distribution system 50 as herein described. Inasmuch as the ad impressions that are to be used to meet the representative demand profile arise over time, an agreement to exploit the ad impressions may rely partly on an estimation of the number and character of ad impressions that will arise. If a media outlet is reasonably sure that a given number of ad impressions of a given type will arise, then the media outlet can commit contractually to using the ad impressions to meet the demand of particular advertisers whose representative profile encompasses ad impressions of that type. In an advertising contract, it is possible for parties to agree to a “best efforts” obligation to produce exploitable ad impressions, but a contract containing obligations to produce a certain number and type of ad impressions may be preferable. In that case, the guaranteed ad impressions can command a better price than potential ad impressions that might be subject to contract but are not guaranteed and are uncertain to arise at all.

This situation is handled in current advertising systems by selling guaranteed ad impressions in advance, and selling the additional ad impressions that may arise under different contractual provisions and effectively in a substantially independent market. The present ad distribution system is configured to aid in unifying these two different markets.

As shown in FIG. 1, the advertisers 22 define a representative demand profile that they deem to be appropriate. The advertisers 22 might study their products, commission surveys, collect information from actual customers and so forth, to identify likely targets for ads for a particular product or ads written perhaps to be appealing to some recipients more than others. The advertisers 22 typically have various rules for associating ads with ad impressions of distinct types, and for distributing ads generally over various subsets of a population, not necessary limited to applying their advertising expenditures only to certain targeted subsets. All such rules and associations make up a representative profile that can be unique to an advertiser or an advertised product.

The media outlets 33 also collect information about their user base and the patterns of user access to and usage of media of one content or another. The media outlets have knowledge of the content of the media and also have knowledge of their users' patterns of access. The media outlets may have subscriber information such as location and demographic data. Some subscriber information can be inferred from a user's access to certain content. All this information is collected and used to study and associate patterns of subscribers and content so as to provide knowledge of the opportunities available to insert advertising that may be of interest to users.

The information collected by media outlets enables projections to estimate the nature and number ad impressions that are likely to become available at a given time. The information can include, for example, an estimated number of users having defined characteristics who are projected to access a particular web page or other media content source over a given time window. Depending on the information collected, the defined user characteristics might include measures of age, gender, income, family associations, etc., with statistical ranges of confidence in the values.

As a result of collection and study of information, the media outlets or their nominee can determine and define a projected probable inventory of ad impressions that may be offered for sale to advertisers. Within statistical limits, the media outlets may believe that an excess inventory of ad impressions may be available. However, the media outlets are not likely to commit as readily to sale of ad impressions under contracts guaranteeing delivery or containing non-performance penalties, when the availability of the excess ad impressions is unsure. The excess ad impressions in that case might be sold on a spot market when it becomes clear that the ad impressions are available, e.g., immediately before the ad impressions might be used.

According to one aspect, the two markets are to be merged insofar as possible, for ad impressions sold under guaranteed contracts and ad impressions sold only when they prove to be available. This is accomplished in part by optimizing the selected proportion of ad impressions that will be committed to guaranteed delivery contracts versus the proportion that will be sold if possible when excess ad impressions prove to be available. This is also accomplished in part by providing competition between guaranteed and non-guaranteed demand when accomplishing the delivery of emerging ad impressions as the ad impressions become available. These steps are accomplished by the ad distribution system 50 as an intermediary between the advertisers 22 and media outlets 33.

The ad distribution system functions to optimize the proportions or the division of ads that will be allocated to guaranteed contracts or to ad hoc spot sales. The optimization can be accomplished during negotiations as to whether to commit to guaranteed sales, but preferably is also accomplished repetitively by the ad distribution system as conditions change over time. In addition to negotiations in advance, the ad distribution system matches demand increments of the representative profiles of advertiser versus projected probable opportunities to use ad impressions, and repetitively updates the projections and rebalances the proportions that are used or planned for use either to satisfy guaranteed obligations or to be sold on the ad hoc spot market. The ad impressions are allocated as a function of price and performance, namely to achieve: (1) a high likelihood that guaranteed obligations are met, (2) a close match of allocated ad impressions with the representative profiles of the advertisers, (3) allocation of the ad impressions to the use that will achieve the highest revenue for the media outlets.

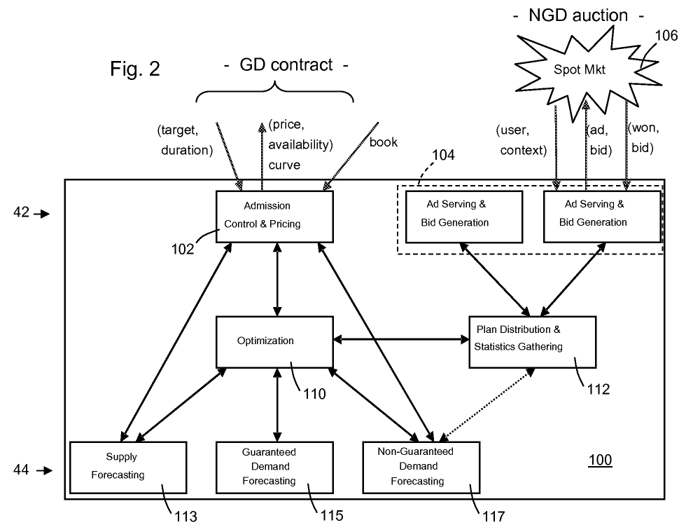

An ad distribution system is shown in FIG. 2 as configured to integrate handling of predetermined commitments to provide ad impressions together with emergent opportunities to make spot sales. The predetermined commitments are generally termed “guaranteed” contracts or guaranteed delivery of ad impressions, but the idea of guaranteed contracts encompasses any commitment entered before the moment of allocation of an ad impression to a demand, when the allocation reduces the total supply of remaining ad impressions that will be available, and thus reduces the number of ad impressions that are might yet be committed to another guaranteed contract or might be allocated for spot sales up to the last possible moment.

The ad distribution system can be embodied as a service of a programmed a network server that manages the allocation of the supply of ad impressions available from subscribing website operators and similar media outlets versus the demand by advertisers to use the ad impressions, optionally providing the interface through which ad content is routed to the media outlets for insertion, as windows, banners and other elements of webpages being composed for display by the respective browser programs that compose the webpages for viewing by users, e.g., when surfing the worldwide Web. In an advantageous embodiment supported by user interfaces for the advertisers and media distributors or outlets, the system and method can be configured to manage allocation of guaranteed-delivery ad impressions in a number projected by media distributors to be available, and also to manage the offering and sale ad hoc of excess ad impressions that are found to be available beyond those that were projected. These excess impressions can be sold at auction and used up to the time at which it becomes apparent that the number of impressions in the actual supply will exceed what was projected.

The marketplace arrangement as shown in FIG. 2 can unify the allocation and sale of ads, eliminating artificial separation between the ad impression inventory that is sold months in advance under agreements entailing guaranteed delivery (i.e., obligations as to the number and nature of impressions and potential penalties for inability to deliver) versus the remaining inventory, normally from overly-conservative estimates and projections, to be sold using a real-time auction, spot market or terms of “best efforts” non-guaranteed delivery.

For instance, the current Yahoo! system for managing advertising serves contracts (i.e., guaranteed ad impression deliveries) their agreed quota before serving non-guaranteed contracts. As a result, high-quality or most sought after impressions are mostly allocated to the guaranteed contracts. This mode for ad impression allocation is acceptable if most advertising is under guaranteed delivery contracts, but it may fail to realize the full potential of the additional ad impressions that are available when the number of ad impressions proves to be greater than the number that was projected. By automated allocation and management of non-guaranteed delivery impressions, including allocation and contractual commitment of ad impressions immediately prior to the time that the impressions become available, a mix of guaranteed and also non-guaranteed contracts can form a unified marketplace whereby an impression can be allocated to a guaranteed or non-guaranteed contract efficiently, based on the value of the impression to the different contracts, and with less value risked on the ability to project ad impression availability far in advance. A unified marketplace for long term (guaranteed) impressions and short term ones as well, enables equitable allocation of ad impression inventory, and promotes increased competition between guaranteed and non-guaranteed contracts.

One aspect of the system is a bidding mechanism that enables guaranteed contracts to bid on the spot-market for each impression and compete directly with non-guaranteed contracts, while still meeting the guaranteed goals for the contracts. This competition is facilitated if the value of ad impressions on the spot market is subject to highly refined targeting. For example, a selection of ad impressions targeted to “one million Yahoo! Finance users from 1 Aug. 2008-31 Aug. 2008” is diluted and potentially less valuable to certain advertisers compared to “100,000 Yahoo! Finance users from 1 Aug. 2008-8 Aug. 2008 who are males between the ages of 20-35 located in California, who work in the healthcare industry and have recently accessed information on sports and autos.”

In order to shift to refined targeting, the advertising industry needs to forecast future ad impression inventory to a fine-grained level of targeting, i.e., numerous variables with tight ranges or close adherence to examples. Advantageously, correlations between different targeting attributes are identified and exploited by producing correlated variable values that can be compared directly to match ad impressions with demand. Taken to a very fine level, it may be appropriate to manage contention in a high-dimensional targeting space with hundreds to thousands of targeting attributes because different advertisers can specify different overlapping targeting combinations. If numerous targeting combinations are accepted and guaranteed, there must be assurance that sufficient inventory will be available.

Referring to FIG. 2, an advertising delivery system 100 coordinates the execution of various system components, operating as a server with several subsystems devoted to arranging for handling the contractual matching of guaranteed ad impressions allocated to demands according to projections, plus spot market sales of ad impressions that become available, and serving ads to fill the ad impressions.

An admission control and pricing sub-system 102 facilitates guaranteed ad contracts, preferably for a time period up to a year in advance of actual presentation of ad impressions that are contracted. This sub-system 102 assists in pricing guaranteed contracts, and is coupled to supply and demand forecasting subsystems for this purpose.

An ad serving sub-system 104 has a subsystem that matches ad guarantees (demands) with opportunities (ad impressions), including serving the guaranteed impressions and also through ad hoc bidding system whereby selected guaranteed impressions may be supplied by deals on the spot market at favorable terms.

The admission control module 102 has input and output signal paths for interacting with sales persons who negotiate and contract with advertisers. A sales person may issue a query that defines a specified target (e.g., “Yahoo! finance users who are California males who like sports and autos”) and the Admission Control module determines and reports the available inventory of ad impressions for the target and the associated price. The sales person can then book a contract accordingly.

The ad server module 104 takes on an ad impression opportunity, which comprises a user such as a web page viewer and a context, such as a URL for the visited page and information on the theme of the content of the web page begin viewed. Other information useful for targeting may be available, such as the succession of URLs visited by the user prior to the visited page. The ad server module 104 returns a guaranteed ad to fill the ad impression opportunity, and determines an amount that the system would be willing to bid for that opportunity in the spot market (the exchange 106).

The operation of the system is orchestrated by an optimization module 110. This module periodically takes into account a forecast of supply (future impressions that are projected), future guaranteed demand (projected guaranteed contracts) and non-guaranteed demand (expected bids in the spot market) that are generated from a supply forecasting module 113, and two demand forecasting modules 115, 117 that are arranged to distinguish between guaranteed and non-guaranteed demand elements. However, as ad impressions are made available, the system can decide whether to use the ad impression to satisfy the guaranteed commitments or to apply them to the spot market.

The optimization module matches supply to demand using an overall objective function as described herein, namely matching instances of ad impressions (supply) to meet instances of demand according to the advertisers' representative profiles of demand, preferably using a norm function that matches supply and demand according to the distance between the variable values of the supply and demand instance attributes in multi-dimensional space. The optimization module sends a summary plan characterizing the optimization results to the admission control and pricing module 102 and to a plan distribution and statistics gathering module 112. The plan distribution and statistics gathering module 112 sends information defining the plan to the ad servers 104. The plan produced by the optimization module can be updated periodically as estimates for supply, demand, and delivered impressions are available, e.g., every few hours.

Given the plan, the admission control and pricing module 102 works as follows. When a sales person issues a targeting query for some duration in the future, the system first invokes the supply forecasting module 113 to identify how much inventory is available for that target and duration. As mentioned earlier, targeting queries can be very fine-grained, thus having numerous values in a multi-dimensional space having numerous coordinate axes. The supply forecasting module uses a scalable multi-dimensional database indexing technique for this purpose, with bit-map indices, to enable correlations between different targeting attributes so that the values of instances of supply and demand have some coordinate axes in common, and so that where values are unknown, a statistical probability may be available either to infer a likely value or to dictate that the representative profile should entail distributing supply or demand instances over a range of values for a coordinate axis.

Generating values on the coordinate axes for supply and demand instances is only a part of the larger problem of allocating supply and demand because there is contention between alternative demands for the same instance of supply and vice versa. For example, if there are two demand contracts: “Yahoo! finance users who are California males” and “Yahoo! users who are aged 20-35 and interested in sports,” it is advantageous to take into account the correlation between the demand instances to avoid double-counting, in this example because male California finance users may have a high correlation with that age bracket and with an interest in sports.

In order to deal with this contention problem in a high-dimensional space, the supply forecasting system preferably computes the match between supply instances as impression samples as opposed to a raw count of available ad impressions. The samples of impressions are used as inputs to compute whether multiple demand contracts are connected to the attributes of a given impression.

Given the impression samples, the admission control module 102 uses the plan communicated by the optimization module 112 to calculate the contention between contracts in the high-dimensional space, and returns an available inventory measure to the sales persons without double-counting. In addition, the Admission Control module calculates a proposed price for each contract and returns that along with the quantity of available impressions.

Given the plan, the ad server module 104 works as follows. When an opportunity is presented, for example because a user's browser is engaged in generating the display of a web page from html data and encounters a graphic that is linked to a web address associated with the ad server, an IP call is made for associated media content (e.g., text, graphics, animation, etc.). The ad server module 104 calculates the contention among contracts for this impression in a manner similar to what is done by the admission control and pricing module when determining contractual terms beforehand. Given this instance of an available ad impression, and with contention information and knowledge about non-guaranteed demands, the ad server module 104 responds by selecting a contract with an instance to be filled. The ad server module generates a bid that serves to evaluate the contract, and sends information on the contract and the bid to the exchange element 106. At this point, it is possible for the exchange to associate an instance of a non-guaranteed contract (i.e., to sell the ad impression rather than to fill it in satisfaction of the guaranteed contract that is in hand). If the ad impression is sold, the ad server can return content provided from the buyer through the exchange module 106. If the terms available over the exchange are less favorable, the ad server 104 returns the content associated with the guaranteed demand instance.

Matching a given set of contracts (representative profile demands having values associated with various variables) versus and a set of impression samples (ad impression instances of supply, also having values associated with various values), is a core task, and is served substantially by the optimization module 110. The task is to decide how to allocate the projected or available ad impressions to satisfy the specifications of the demand contracts. One of the goals is a representative allocation. When a contract demand might be satisfied by multiple eligible ad impression types (each of which would contribute in some degree to meeting the demand), it is desirable to allocate some volume of each eligible impression type to corresponding contract demands. In short, it is desirable to allocate supply instances that have a given set of attribute values, to favor targets who have matched attribute values, but not to allocate all the supply to targets based on one attribute value at the expense of others. It is desirable to spread the allocation volume in a manner that is related to the number of instances of all impression types and demand instances, for example proportionately. Advantageously, the allocation favors but does not serve exclusively, those matches wherein certain variable attributes are close in value (i.e., the viewer in context closely meets one of several measures targeted) at the expense of other attributes.

In the unified marketplace, there are two competing sources of demand to which a particular ad impression might be allocated. An ad impression might used to satisfy a guaranteed delivery (GD) obligation under a contract, or might be sold on the non-guaranteed delivery (NGD) spot market. In a market that is not unified, and assuming that there was sufficient demand from advertisers at the prices offered, the ad impressions of the media distributors might be contractually guaranteed only insofar as their projected availability has a high level of confidence. It is an aspect of the present technique, however, not to allocate only on confidence in availability but instead to seek to maximize the efficiency and value of the allocation to both portions of the demand. Accordingly, the optimization module is used to seek an efficient division of allocations between the guaranteed and spot markets.

When impressions are allocated to guaranteed delivery contracts, the representativeness of the allocation is the major goal, namely closely to match the allocation to the number and type of ad impressions that define the representative profiles of the advertisers. On the other hand, when ad impressions are sold on the non-guaranteed delivery spot market, the goal is merely revenue.

The total available ad impressions are a finite supply. If an impression is allocated to guaranteed delivery, that impression is not available for non-guaranteed demand, and vice versa. The marginal revenue that might be obtained from sale of an ad impression on the spot market therefore is compared directly with the marginal value of using that same ad impression to satisfy a guaranteed delivery obligation. As explained herein, this gives a basis in which to make reasoned decisions as to what proportion of available ad impressions should most efficiently be devoted to meeting guaranteed delivery obligations and what proportion should be sold on the ad hoc spot market, for example at auction. Such decisions are enabled in the optimization module 110.

The marginal revenue from a spot market sale of an ad impression is a lost opportunity that is comparable to a cost for a guaranteed delivery allocation of that ad impression. One task of the optimization module 110 is to decide how to balance the allocations between guaranteed delivery contracts and the non-guaranteed delivery spot market to achieve efficiency and other business goals.

The question of whether to allocate to guaranteed or non-guaranteed allocations is regarded herein as a multi-objective optimization problem with the number and marginal revenue of both allocation categories contributing to a common total but their respective contributions competing for the available supply. Both guaranteed delivery value (which equates to representativeness) and non-guaranteed delivery market revenue (which as an opportunity cost can be assessed against guaranteed delivery value) are modeled explicitly as described herein. Modeling in this way provides a framework to test the results of different functions for evaluating representativeness, enabling the model to identify a corresponding efficient allocation between guaranteed and spot market allocations. The model effectively provides business controls that when imposed on a mathematical optimization that produces a trajectory or range of potential control points, establishes one point in the range to be used as the basis of control. This result accrues using a methodology that establishes a monetary value equivalent to the value of representativeness, for use in solving a multi-objective optimization problem.

The method is modeled mathematically and shown graphically using the variables listed and defined in Table 1:

TABLE I

i: index of supply, i = 1, . . . , I
j: index of demand, j = 1, . . . , J
sᵢ: volume of supply i
dⱼ: volume of demand j
rᵢ: NGD reserve price of supply i
vⱼ: value or priority attributed to demand j
Bⱼ: set of supply that is eligible for demand j
Sⱼ: total supply volume that is eligible for demand j, i.e.,
${\sum }_{i ∈ {B}_{j}} {S}_{i}$
xᵢⱼ: allocation volume from supply i to demand j
zᵢ: volume of supply i sold to NGD market
λᵢ: Lagrangian multiplier (shadow value) associated with supply i
μᵢ: Lagrangian multiplier (shadow value) associated with demand j

It is assumed in this model that there is a function f(xᵢⱼ) representing the incremental value of the representativeness in a guaranteed delivery contract of successfully making an allocation x from supply increment i to demand increment j that satisfies the advertiser's representative profile. This function is stated only generally at this stage. There is a more concrete function for determining the revenue of a sale of ad impressions on the non-guaranteed delivery market, namely the product of the reserve price r times the quantity z allocated. It is the job of the optimizer somehow to maximize the value of transactions with respect to function f(xᵢⱼ) and also with respect to revenue. It is assumed that the allocations x to satisfy guaranteed and allocations z to non-guaranteed sales will equal the supply s. It is further assumed that the total of allocations to guaranteed demand must equal the total guaranteed demand. Both the guaranteed demand and spot sales are greater than or equal to zero. These relationships are stated as follows:

$$max \{ f ( {x}_{ij} ) , {\sum }_{i}^{ } {r}_{i} {z}_{i} \}$$

$$s . t . {\sum }_{j}^{ } {x}_{ij} + {z}_{i} = {s}_{i} , ∀ i$$

$${\sum }_{i}^{ } {x}_{ij} = {d}_{j} , ∀ j$$

$${x}_{ij} \geq 0 , ∀ i , j$$

$${z}_{i} \geq 0 , ∀ i$$

Up to this point, the general function f(xᵢⱼ) standing for the representativeness of an allocation, namely its value to an advertiser who has entered a guaranteed delivery contract for ad impressions that are defined by some representative profile, is assumed to exist but has not been defined. In a practical application, f(xᵢⱼ) can be a value measure based on goal programming, such as the rating or extent to which an allocation matches a set of criteria dictated by the advertiser. Among other possibilities, determining the value can involve calculating the match or mismatch of the values of numerous variables that respective characterize an ideal targeted user or a range of users, versus the values of similar variables to characterize visitors to a webpage who may view an allocated ad impression. The non-negative variable zᵢ transform the supply constraints to equalities for the total of supply and demand.

Since zᵢ is actually the excess supply inventory to be sold on the non-guaranteed delivery spot market, and the totals of supply and demand are equated, the term

$${\sum }_{i} {r}_{i} {z}_{i}$$

can be viewed as the opportunity cost calculated with respect to the non-guaranteed delivery spot market, but pertinent to assessing the value of representativeness because an allocation to the spot market leaves one less potential allocation to serve representativeness.

Given that the totals are constant and supply equals demand, a range of allocation pairs is possible wherein more of the total is allocated to one or the other of guaranteed delivery and non-guaranteed spot sale, or the two allocations are equal, or one or the other of the allocations is equal to the total supply and the other allocation is zero.

One might solve the relationships using a representation of representativeness that equates to monetary value. However, representativeness is a matter of the quality of ad impressions provided to suit the needs of an advertiser, as well as the quantity. Therefore, an appropriate solution of the relationships enables the introduction of a weighting factor that effectively specifies the relative value of representativeness. The parameter γ>0 is the weight for the representativeness utility, and when included modifies the relationships as follows in a weighted sum solution:

$$max γ f ( {x}_{ij} ) + {\sum }_{i}^{ } {r}_{i} {z}_{i}$$

$$s . t . {\sum }_{j}^{ } {x}_{ij} + {z}_{i} = {s}_{i} , ∀ i$$

$${\sum }_{i}^{ } {x}_{ij} = {d}_{j} , ∀ j$$

$${x}_{ij} \geq 0 , ∀ i , j$$

$${z}_{i} \geq 0 , ∀ i$$

In a weighted sum solution, the shadow or marginal value λ of the supply constraint is always no less than the reserve price: λᵢ≧rᵢ. Since the weighting is variable and the general representativeness utility function f(xᵢⱼ) also can allow for different formats, this model have some flexibility to plug in representativeness utility functions for different business or engineering reasons. The representativeness can be a matter of matching values for numerous values or combinations of variables. One possibility is to use a norm operator such as the L₁ norm, L₂ norm, L_{∝} norm or to use entropy or relative entropy (sometimes known as KL-divergence to calculate a measure of the extent to which two multiple-variable points are near in value or different in value based on the distance between points in multi-dimensional space. It is possible to calculate point-t-point distances in a straight forward manner, although there may be numerous points and numerous variables to take into account.

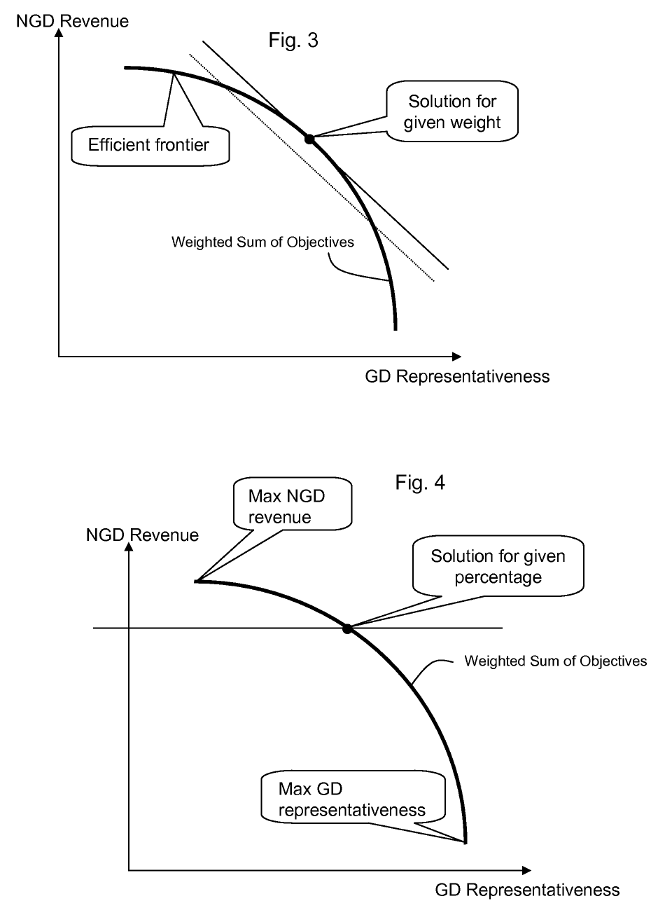

Multi-objective solutions as described can have a range of solutions. In a simple example, if two variable values must equal a sum and either of the variable values may be larger or smaller than the other, then the solution graphs to a straight line and the potential solutions are the points along the line. In the case of a weighted function, as shown in FIG. 3, the weight variable in a weighted sum function affects the slope of a line.

In the modeled situation, the total supply and the total demand are equal, but the highest revenues are likely to be achieved from a mix of guaranteed and non-guaranteed allocations rather than either type of allocation exclusively. Assuming that the potential allocations fall over a range of characteristics, some candidate allocation are well matched to a given advertiser's representative profile and some are not. Revenue is enhanced by allocating the most representative candidates to guaranteed ads. On the opposite end of the scale, allocating all the allocations to spot sales tends to average away the value of the highly representative ones. Conversely, if most of the allocations are made to guaranteed allocations, the advertiser is accepting some relatively poorly representative allocations, and may reasonably pay less than it might for the whole contract. For these reasons, the slope or marginal revenue associated with guaranteed or non-guaranteed revenue is a curve that falls off at its extremes, as shown in FIG. 3.

A solution for a multi-objective optimization is deemed efficient if no solution can be found that is better as to all the multiple objectives and the given solution is better in at least one of the objectives. All the efficient solutions constitute an efficient frontier. The efficient frontier is along the curved line graphed in FIG. 3.

In the multi-objective space that is modeled, the weight γ applied to representativeness, determines the slope of a line. Solving the multi-objective optimization problem using weighting together with a curve that represents the efficient frontier revenue for all possible combinations of proportionate allocations to guaranteed deliveries and spot sales, involves finding the point at which a line of the slope determined by the weight factor touches the efficient frontier as a tangent. This generates one efficient solution from the corresponding weight γ, as shown in FIG. 3. The solution represents an allocation between guaranteed delivery value (the total representativeness to the advertisers' profiles) versus revenue to be obtained from spot sales. The solution is followed by the optimization module 110 in providing guidelines for negotiation of guaranteed delivery contracts and also in determining the allocation of emergent allocations between satisfying guaranteed delivery obligations and selling on the spot market. If the efficient frontier is convex, then any efficient solution is attainable by choosing the right γ.

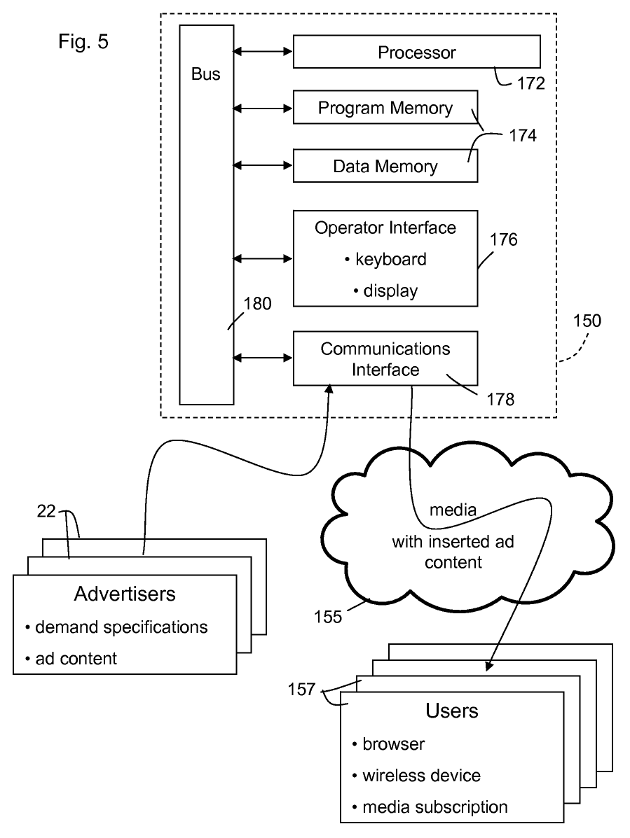

The multi-objective optimization can also be solved in an alternative way by defining a goal and calculating the solution using the goal as an additional constraint. The idea is to determine the maximum value of one variable (e.g., guaranteed delivery representativeness) and to use that value to determine the corresponding value if the objective (e.g., non-guaranteed delivery revenue) has a goal imposed. An example is shown in FIG. 4. An efficient frontier curve is shown, between the extreme solutions of maximizing for guaranteed delivery representativeness or maximizing for non-guaranteed delivery revenue. By first optimizing for just one objective (e.g., maximum non-guaranteed delivery revenue), and then imposing a reasonable goals, such as a percentage of that optimized value, the efficient frontier curve produces a corresponding value for the other objective, namely an operating point of the desired level of guaranteed delivery representativeness.

The foregoing solution is demonstrated by the following relationships:

$$max {\sum }_{i}^{ } {r}_{i} {z}_{i}$$

$$s . t . {\sum }_{j}^{ } {x}_{ij} + {z}_{i} = {s}_{i} , ∀ i$$

$${\sum }_{i}^{ } {x}_{ij} = {d}_{j} , ∀ j$$

$${x}_{ij} \geq 0 , ∀ i , j$$

$${z}_{i} \geq 0 , ∀ i$$

Further defining

$${R}^{*} = {\sum }_{i}^{ } {r}_{i} {z}_{i}^{*} ,$$

where z*ᵢ represents the solution, the value for representativeness is obtained:

$$max f ( {x}_{ij} )$$

$$s . t . {\sum }_{j}^{ } {x}_{ij} + {z}_{i} = {s}_{i} , ∀ i$$

$${\sum }_{i}^{ } {x}_{ij} = {d}_{j} , ∀ j$$

$${\sum }_{i}^{ } {r}_{i} {z}_{i} \geq η {R}^{*}$$

$${x}_{ij} \geq 0 , ∀ i , j$$

$${z}_{i} \geq 0 , ∀ i$$

The parameter ηε[0,1] specifies the percentage of non-guaranteed delivery revenue that the optimizer 110 is programmed to protect. Specifying the goal as a percentage makes an intuitive control input, for example chosen by the dictates of management, that is perhaps more practical than defining a weight parameter γ to rate the relative importance of marginal representativeness and marginal spot sale revenue.

In setting such a goal,the management may use their business insight to evaluate long term revenue, for which our proxy is “representativeness” versus short term revenue as represented by the sum Σᵢrᵢxᵢ

There is a disadvantage to choosing a solution wherein an operating point of one variable is selected as a percentage of a maximum value of the other variable. It is not guaranteed that λᵢ≧rᵢ. To solve this problem, it is possible to find a weight value γ that corresponds to η (i.e., to find the slope of a tangent at the operating point) and then to solve for a value on the weighted sum of objectives curve. Let ρ be the Lagrangian multiplier for the revenue constraint and set

$$γ = \frac{1}{ρ} .$$

The result is the same optimal allocation as the allocation obtained from obtaining an operating point of one variable by selecting a percentage of a maximum value of the other variable, and also guarantees pᵢ≧rᵢ.

$$max \frac{1}{ρ} f ( {x}_{ij} ) + {\sum }_{i}^{ } {r}_{i} {z}_{i}$$

$$s . t . {\sum }_{j}^{ } {x}_{ij} + {z}_{i} = {s}_{i} , ∀ i$$

$${\sum }_{i}^{ } {x}_{ij} = {d}_{j} , ∀ j$$

$${x}_{ij} \geq 0 , ∀ i , j$$

$${z}_{i} \geq 0 , ∀ i$$

The practical effect of using the multi-objective optimization model as described is to employ a programmed technique in the optimization module 110 of the ad distribution system shown in FIG. 2, as a methodology to convert or compare a measure of representativeness (namely the degree of conformance to advertisers' representative profile) into a monetary value that can be meaningfully compared against the more readily calculated revenue that is associated with the marginal value of a sale of a given quantity of ad impressions on the spot market.

The weight parameter γ can be viewed as a conversion rate from a variable that corresponds to representativeness, to monetary value. It shows by the solution on the efficiency frontier how much one unit of representativeness is worth in terms of the one unit of non-guaranteed delivery opportunity cost, which is a monetary value. The conversion rate depends on where the solution is found is on the efficient frontier. When an efficient solution is close to the upper-left end of the frontier shown in FIGS. 3 or 4, corresponding to a low representativeness level, γ is big, which means that an incremental unit of representativeness is worth a high monetary value. On the other hand, when the representativeness level already is high, γ is small, indicating a low monetary value for an incremental unit of representativeness.

In practice, the η parameter can be affected by business requirements, for example to achieve a reputation for representativeness that will appeal to advertisers, or alternatively to make the distribution of ad impressions very agile and responsive to changes in the marketplace including the incremental value of ad impressions on the spot market, generally independently of the representative profiles of the advertisers under contract, but in a manner that is responsive to changing conditions and the resulting changes in the value of emergent (or excess) ad impressions. The goal programming solution based on business requirements and selection of percentages generates ρ, the Lagrangian multiplier of the NGD revenue protection constraint. As a result, γ=1/ρ can be regarded as the conversion rate from allocation representativeness to monetary value.

The advertising distribution system as disclosed mediates and distributes advertising opportunities, especially insertions of ads on web pages, according to advertisers' representative targeting profiles. The number and characteristics of future ad impressions is forecast. A portion is allocated to guaranteed-delivery advertiser contracts and the remainder is offered on a spot market. A division between guaranteed and spot market allocations is sought to maximize revenue, taking into account a value associated with meeting the advertisers' representative profiles. The value of representativeness can be inferred from the marginal revenue of a spot market sale, and optionally weighted. The guaranteed and spot market revenues for all possible allocations produces a curve. An operating point on the curve is determined by selecting a weighting factor or selecting a proportion of total revenue that shall be attributable to representativeness.

The techniques as described are not limited to an Internet based advertising distribution system and can be applied to other instances where there is a need to allocate supply and demand while delivering value in exchange for revenue wherein the demand increments fall into categories having at least one of quantities and revenues that differ between the categories. Inasmuch there are totals of quantity and revenue, it is known that an allocation to one category reduces the allocation to the other category. A relationship can be projected as described that demonstrates the quantities and revenues that result from allocating the total supply more or less to one or the other of the at least two distinct categories, from zero to 100% or at least from zero to a maximum proportion of the total supply. What remains is to determine the operating point.

One or more goals is imposed on the relationship in addition to accounting for distribution of all the supply to one or the other of the allocation categories. The goal helps to determine a point in the relationship curve that corresponds to a particular proportionate allocation. The supply increments are then allocated to the demand increments at this particular proportion in at least one of a planned allocation and an actual allocation including delivering the supply increments. This allocation can be used when planning the proportion of projected ad impressions will be devoted to guaranteed delivery contracts, or can be used when deciding how to use the successive ad impressions that prove to be available, for example when web page hits occur enabling the transmission of ad copy for insertion into the web page as rendered.

The disclosed allocation technique can incorporate functions that calculate the value of representativeness so as to rate the extent to which emerging ads meet advertiser representativeness specifications, i.e., functions that allow a comparison of ad impression characteristics and advertiser specifications as a measure of quality. Alternatively, the allocation can be based on an inferred monetary value based on the opportunity cost of employing an ad impression to meet a guaranteed demand. The opportunity cost is at least equal to the amount that the ad impression would bring in on the spot market. It is advantageous, however, to weight the importance of representativeness versus revenue, preferably to assume that a high degree of representativeness (high ad quality from the advertisers' viewpoint) is an important aspect for the ad distribution service to deliver. Weighting can be accomplished by a factor that favor representativeness or by choosing a proportion of revenue that should be attributable to representativeness, and thus contributes to long term customer goodwill.

This disclosure encompasses methods, systems for practicing the methods, programmable data processing apparatus and/or program data carriers that store code enabling a general purpose computer to practice the subject matter when coupled in data communication with sources of advertiser information, sources of media distributor information, and advertising copy that can be inserted when opportunities are reported by the media distributors.

FIG. 5 illustrates a practical embodiment as a block level diagram wherein the ad distribution system is configured as a computer system 150 that is coupled for data communications, for example to provide media in the form of html web pages and graphics files over a communication path traversing the Internet 155 to various remote users 157, who may be appropriate targets for advertising content provided by advertisers 22. The computer system 150 can be associated with a service such as a directory service or search engine, or a retail or wholesale outlet or any of various operations whose activities include transmission of media to users 157.

The system 150 as shown can include one or more processors 172, implemented using a general or special purpose processing engine such as a microprocessor, controller or other control logic configuration. In the example shown, processor 172 is coupled via a bus 180 to program and data memory 174, an interface 176 for input/output with a local operator, including, for example, a keyboard, mouse, display, etc., and a communications interface 178. The communications interface is generally shown coupled for communications with advertisers 22 or over the Internet with remote users 157; however it is likewise possible that other specific techniques could be employed to deliver data from the advertiser to system 150, such as hand transferred data carriers, telephone discussions or even paper exchanges. The manner of transmitting media to the users 157 likewise is not limited to web page data transmission and could comprise, for example cable or other video program distribution among other possible embodiments.

The memory 174 of the computing system advantageously includes random access volatile memory and ROM, disc or flash nonvolatile memory for initialization. The program instructions are stored in and executed from the program memory to carry out the functions discussed above. The memory can include persistent data storage for accumulated data respecting advertiser and user information, for example on hard drives. Advantageously, the memory 174 of system 150 can contain locally stored versions of advertising copy that is to be inserted, especially for servicing guaranteed demand. The memory 174 also can receive, preferably store and insert at least some advertising copy from advertisers 22 who undertake to use ad impressions obtained on the ad hoc spot market.

Alternatively or in addition, at least part of the advertising copy to be inserted can be stored remotely and accessed by providing to the browser at the user system the appropriate URLs identifying advertising content to be inserted. For example, system 150 can store and submit to the user browser a network address for graphics or other content to be inserted, which address refers to a system at or associated with the advertiser 22, which system is coupled for web communications and is configured to respond to an IP request for addressed graphic or media content. That content can be obtained by bidirectional IP communications between the browser and the system where the content is stored

The persistent storage devices of memory 174 may include, for example, a media drive and a storage interface for video or other substantial storage capacity needs. The media drive can include a drive or other mechanism to support a storage media. For example, a hard disk drive, a floppy disk drive, a magnetic tape drive, an optical disk drive, a CD or DVD drive (R or RW), or other removable or fixed media drive may be employed. The storage media can include, for example, a hard disk, a floppy disk, magnetic tape, optical disk, a CD or DVD, or other fixed or removable medium that is read by and written to by the media drive.

In this document, the terms “computer program medium” and “computer useable medium” and the like are used generally to refer to media such as, for example, memory 174, various storage devices, a hard disk and hard disk drive and the like. These and other various forms of computer useable media may be involved in carrying one or more sequences of one or more instructions to processor 172 for execution. Such instructions, generally referred to as “computer program code” (which may be grouped in the form of computer programs or other groupings), when executed, enable the computing system 150 to perform features or functions of the embodiments discussed herein.

The foregoing subject matter has been disclosed with respect to a range of examples and preferred embodiments. The invention is not limited to the embodiments disclosed as examples. Reference should be made to the appended claims rather than the foregoing description of examples, in order to assess the scope of exclusive rights claimed.

What is claimed is:

1. A method for allocating supply and demand in connection with delivering value in exchange for revenue, comprising the steps of:
defining a plurality of supply increments that form a total supply to be allocated to meet demand increments, wherein the demand increments fall into at least two distinct categories having at least one of quantities and revenues that differ between said categories;
projecting by computer data processing steps a relationship of at least one of the quantities and revenues for allocating the total supply between one and the other of the at least two distinct categories, wherein the proportions range from zero to a maximum proportion of the total supply, wherein a sum of projected quantities for all said proportions equals the total supply, wherein the relationship defines a range of possible proportions of allocation between the two categories, and wherein the relationship is represented by data stored in a computer data memory;
imposing at least one goal on the relationship, wherein the goal determines a point in the relationship that corresponds to a particular proportion in said relationship of quantities and revenues; and,
allocating the supply increments to the demand increments at said particular proportion by at least one of storing in the computer data memory a planned allocation and transmitting data identifying an actual allocation that causes delivery of the supply increments.

2. The method of claim 1, wherein allocating the supply increments to the demand increments is constrained by at least two objectives, wherein one of the objectives is to maximize an extent to which characteristics of the supply increments that are allocated match requirements of the demand increments to which the supply increments are allocated, and a second one of the objectives is to maximize a total revenue, and wherein the objectives are embodied in programming that at least partly controls the computer data processing steps.

3. The method of claim 2, further comprising encoding the characteristics of the supply increments and the requirements of the demand increments according to at least one measure that enables discrimination of candidates for allocation from among the supply increments that meet the demand increments.

4. The method of claim 3, wherein the measure includes representativeness of the supply increments to the demand requirements and further comprising characterizing the supply increments and the requirements of the demand increments according to values for a plurality of variables, rating the candidates for allocation among the supply increments by comparing values of at least a subset of the variables, and storing a result thereof in the computer data memory for use in allocating the supply increments to the demand increments.

5. The method of claim 3, wherein the demand requirements include distribution of at least one subset of the supply increments over users according to a range of user characteristics, and further comprising allocating according to said distribution.

6. The method of claim 2, wherein the supply increments comprise advertising impressions, further comprising projecting a number and character of said advertising impressions expected to become available at a future time, and wherein one of the categories of demand increments comprises a contractually committed portion of the advertising impressions that are expected to become available and an other of the categories of demand increments comprises an additional portion of advertising impressions that actually become available.

7. The method of claim 6, further comprising establishing from the allocation a limit restricting contractual commitment of the advertising expected to become available according to said particular proportion, storing an indication of said limit, and controlling subsequent contractual commitment SO as to remain within the limit.

8. The method of claim 6, wherein imposing the goal on the relationship comprises weighting values of advertising impressions in the two categories, determining a weighted sum of the values at each point in the relationship defining the range of possible allocations, and obtaining and storing an indication of said particular proportion according to the weight.

9. The method of claim 8, further comprising inferring, from a revenue associated with sale of an ad impression in the additional portion, a monetary value of said extent to which the characteristics of the supply increments match the requirements of the demand increments, factoring said inferred monetary value into the relationship of the quantities and revenues, and obtaining and storing an indication of said particular proportion according to the inferred monetary value.

10. The method of claim 9, further comprising weighting a relative importance of said revenue and said extent to which the characteristics match, by selecting a weight factor that favors one of the revenue and the extent in said relationship.

11. The method of claim 9, further comprising weighting a relative importance of said revenue and said extent to which the characteristics match, by selecting a proportion of total revenue that shall be attributable to the extent to which the characteristics of the supply increments match the requirements of the demand increments, said proportion corresponding to an operating point in said relationship, and further comprising storing an indication of said operating point and controlling said allocating to seek the operating point.

12. An ad distribution system for mediating a market of advertising impressions offered by media outlets to supply a demand of advertisers for advertising impressions that meet advertiser representative advertising profiles, comprising:
a data processing system having a forecasting subsystem operable to generate a forecast of a number and character of ad impressions that are expected to become available to at least one media outlet, a first contracting subsystem operable to commit a first portion of the forecast to predetermined advertising obligations, and a second contracting subsystem operable to submit a remaining second portion of the forecast for later sale;
wherein the data processing system includes an optimization subsystem operable to allocate respective proportions of the forecast number of ad impressions to the first and second portions, the optimization system establishing a relationship of at least one of quantities and revenues resulting from allocating the total supply more or less to one or the other of two categories that include said predetermined advertising obligations and said later sale, the relationship defining a range of possible proportions of allocation between the two categories;
imposing at least one goal on said relationship, wherein the goal determines a point in the relationship that corresponds to a particular proportion in said relationship of quantities and revenues;
wherein the data processing system is programmed to produce, store and output indicia controlling application of the ad impressions in said particular proportions.

13. The data processing system of claim 12, wherein imposing the goal on the relationship comprises weighting values of ad impressions in the first portion and ad impressions in the second portion, and determining a weighted sum of the values at each point in the relationship defining the range of possible allocations.

14. The data processing system of claim 12, wherein the optimization subsystem is programmed to determine, from a revenue associated with sale of an ad impression in the second portion, a monetary value of an extent to which characteristics of ad impressions committed to the first portion match the advertiser representative profiles.

15. The data processing system of claim 14, wherein a relative importance of said revenue and said extent to which the characteristics match, is determined in part by selecting a weight factor in said relationship, that favors one of the revenue and the extent to which said characteristics match.

16. The data processing system of claim 15 wherein a relative importance of said revenue and said extent to which the characteristics match, is determined in part by selecting a proportion of total revenue that shall be attributable to the extent to which the characteristics of the supply increments match, said proportion corresponding to an operating point in said relationship.
